(19) United States
(12) Patent Application Publication
(10) Pub. No.: US 2019/0166043 A1
(43) Pub. Date: May 30, 2019

(54) INFORMATION PROCESSING APPARATUS AND METHOD THEREOF

(71) Applicant: FUJITSU LIMITED, Kawasaki-shi (JP)

(72) Inventor: Chunghan Lee, Yokohama (JP)

(73) Assignee: FUJITSU LIMITED, Kawasaki-shi (JP)

(21) Appl. No.: 16/183,777

(22) Filed: Nov. 8, 2018

(30) Foreign Application Priority Data
Nov. 24, 2017 (JP) 2017-226041

(51) Int. Cl. H04L 12/721; H04L 12/747; H04L 12/931

(52) U.S. Cl. CPC H04L 45/38; H04L 49/70; H04L 45/742

(57) ABSTRACT

An information processing apparatus includes a memory and a processor coupled to the memory. The processor is configured to relay flows each including a stream of packets. The processor is configured to collect information of a candidate flow based on information of the relayed flows. The candidate flow is a candidate for a flow to be estimated as a target flow having a predetermined characteristic. The processor is configured to calculate a penalty value for the candidate flow based on information included in a packet of the candidate flow. The penalty value indicates a possibility that the candidate flow does not have the predetermined characteristic. The processor is configured to estimate the candidate flow as the target flow based on the calculated penalty value. The processor is configured to output information of the candidate flow estimated as the target flow.

### CROSS-REFERENCE TO RELATED APPLICATION

This application is based upon and claims the benefit of priority of the prior Japanese Patent Application No. 2017-226041, filed on Nov. 24, 2017, the entire contents of which are incorporated herein by reference.

### FIELD

The embodiment discussed herein is related to an information processing apparatus and a method thereof.

### BACKGROUND

In a network used in an information communication system, communications are carried out by various kinds of flows. Here, the flow is a stream of a packet group identified based on the starting point of a communication and the ending point of the communication. The starting point and ending point of the communication are identified as a combination of information processing apparatus and application, for example.

If a flow having a specific characteristic is identified from among various kinds of flows, path control, congestion control, and so forth may be carried out on the identified flow. For example, if a long flow is identified in a data center network (DCN), path control to change the path of the long flow may be carried out. Here, the long flow is a flow in which transmission of data continues for a predetermined period or more. The throughput of the long flow is high.

In the DCN, a virtual switch implemented by software in an information processing apparatus is widely used. The virtual switch has advantages that the extensibility is higher, the development cost is lower, and so forth compared to a physical switch.

In the virtual switch, packets are processed by using two kinds of tables in different formats. FIG. 19 is a diagram for explaining a mechanism of processing packets by a virtual switch. As illustrated in FIG. 19, the virtual switch processes packets by using an openflow (OF) table and a flow cache.

In processing of a packet using the OF table, an action for the packet is determined based on communication information of the packet through pipeline processing using plural tables. The communication information is information to identify the flow of the packet and includes, for example, a transmission source internet protocol (IP) address, a transmission destination IP address, a transmission source port number, a transmission destination port number, and a protocol. The action includes, for example, specifying the next table, specifying the output destination port of the packet, instructing correction of the header. The OF table is held in a user space.

In the flow cache, information of the action determined by using the OF table is cached in association with the communication information. In the flow cache, entries obtained through gathering similar pieces of communication information in units of subnet or using a wildcard are stored. FIG. 20 is a diagram for explaining a relation between a flow cache entry and OF table entries. As illustrated in FIG. 20, for example, a flow cache entry of “192.168.0.0/16” includes OF table entries of “192.168.1.100/24”, “192.168.100.7/24”, “192.168.2.21/24”, and so forth.

The virtual switch retrieves an action corresponding to the communication information of a packet from the flow cache. If no entry corresponding to the packet exists in the flow cache, the virtual switch determines an action for the packet by using the OF table and stores an entry including the communication information and the determined action in the flow cache. The flow cache exists in a kernel. For this reason, the speed of processing packets using the flow cache is higher than processing packets using the OF table.

Related techniques are disclosed in, for example, International Publication Pamphlet No. WO 2011/102312, International Publication Pamphlet No. WO 2011/068091, and Japanese Laid-open Patent Publication No. 2015-186149.

### SUMMARY

According to an aspect of the present invention, provided is an information processing apparatus including a memory and a processor coupled to the memory. The processor is configured to relay flows each including a stream of packets. The processor is configured to collect information of a candidate flow based on information of the relayed flows. The candidate flow is a candidate for a flow to be estimated as a target flow having a predetermined characteristic. The processor is configured to calculate a penalty value for the candidate flow based on information included in a packet of the candidate flow. The penalty value indicates a possibility that the candidate flow does not have the predetermined characteristic. The processor is configured to estimate the candidate flow as the target flow based on the calculated penalty value. The processor is configured to output information of the candidate flow estimated as the target flow.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for explaining a flow estimation method employed by a virtual switch according to an embodiment;

FIG. 2 is a diagram for explaining ECN;

FIG. 3 is a diagram for explaining an Ex flow;

FIG. 4 is a diagram that represents characteristics of flows in a DCN;

FIG. 5 is a diagram illustrating a functional configuration of a virtual switch according to an embodiment;

FIG. 6 is a diagram illustrating an example of a candidate flow table;

FIG. 7 is a diagram illustrating an example of a cache entry table;

FIG. 8 is a diagram for explaining update of a penalty performed by a flow filter unit;

FIGS. 9A and 9B are diagrams illustrating time-series operations of a virtual switch;

FIG. 10 is a diagram for explaining a flow estimation method in which a measurement slot and an estimation slot are divided into multiple slots;

FIGS. 11A and 11B are diagrams illustrating time-series operations of a virtual switch in a case of using the flow estimation method illustrated in FIG. 10;

FIG. 12 is a diagram illustrating an example of a case in which a long flow exists;

FIGS. 13A and 13B are diagrams illustrating time-series operations of a virtual switch in a case in which a long flow exists;

FIG. 14 is a diagram illustrating an example of a case in which a long flow does not exist;

FIGS. 15A and 15B are diagrams illustrating time-series operations of a virtual switch in a case in which a long flow does not exist;

FIGS. 16A and 16B are flowcharts illustrating a process performed by a flow measurement unit;

FIGS. 17A and 17B are flowcharts illustrating a process performed by a flow estimation unit;

FIG. 18 is a diagram illustrating a hardware configuration of a computer in which a virtual switch operates;

FIG. 19 is a diagram for explaining a mechanism of processing packets by a virtual switch;

FIG. 20 is a diagram for explaining a relation between a flow cache entry and OF table entries; and

FIG. 21 is a diagram for explaining a problem of flow identification.

### DESCRIPTION OF EMBODIMENT

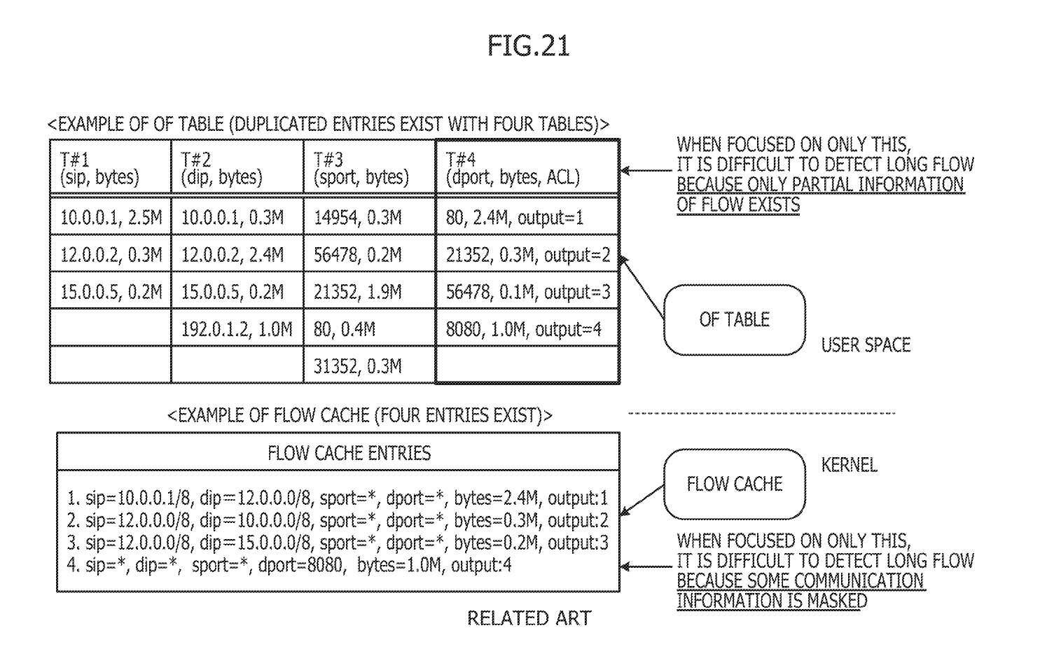

In relay apparatus using the OF table and the flow cache, there is a problem that information of the flow is distributed and it is difficult to efficiently identify a flow having a predetermined characteristic. FIG. 21 is a diagram for explaining a problem of flow identification. In FIG. 21, the OF table includes four tables T#1 to T#4.

In T#1, the transmission source IP address (sip) and the traffic volume (the total number of bytes) (bytes) are represented and other kinds of information are omitted. In T#2, the transmission destination IP address (dip) and the traffic volume (the total number of bytes) (bytes) are represented and other kinds of information are omitted. In T#3, the transmission source port number (sport) and the traffic volume (the total number of bytes) (bytes) are represented and other kinds of information are omitted. In T#4, the transmission destination port number (dport), the traffic volume (the total number of bytes) (bytes), and action (ACL) are represented and other kinds of information are omitted.

In the flow cache, the transmission source IP address and the subnet mask (sip=), the transmission destination IP address and subnet mask (dip=), the transmission source port number (sport=), the transmission destination port number (dport=), the traffic volume (the total number of bytes) (bytes=), and action (output:) are represented. “*” is a wildcard that matches any.

For example, when focused on T#4, only partial information of the flow exists in T#4 and therefore it is difficult to identify a long flow from T#4. Regarding the flow cache, because the stored entries are obtained through gathering in units of subnet or using a wildcard regarding the communication information of the flow, some communication information is masked and it is difficult to identify a long flow from the flow cache.

An embodiment will be described in detail below with reference to the drawings. This embodiment does not limit disclosed techniques.

### Embodiment

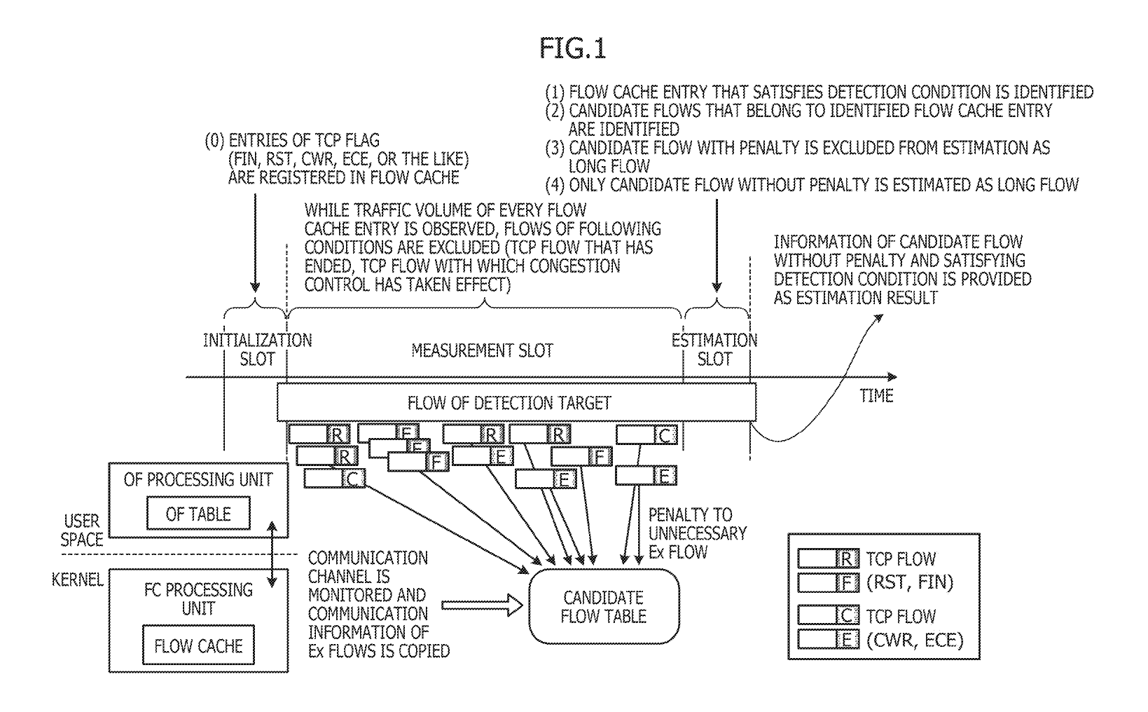

First, a flow estimation method employed by a virtual switch according to the embodiment will be described. FIG. 1 is a diagram for explaining a flow estimation method employed by a virtual switch according to the embodiment. As illustrated in FIG. 1, the virtual switch according to the embodiment executes a flow estimation process in an initialization slot, a measurement slot, and an estimation slot. Here, the slot represents a time zone.

In the initialization slot, the virtual switch according to the embodiment stores, in a flow cache, entries relating to packets in which the transmission control protocol (TCP) flag is FIN, RST, CWR, ECE, or the like (0). A packet in which the TCP flag is FIN is a packet sent when a TCP connection terminates. A packet in which the TCP flag is RST is a packet sent when communication is reset. By storing entries relating to packets in which the TCP flag is FIN or RST in the flow cache as above, the virtual switch according to the embodiment may detect FIN or RST and carry out designated action.

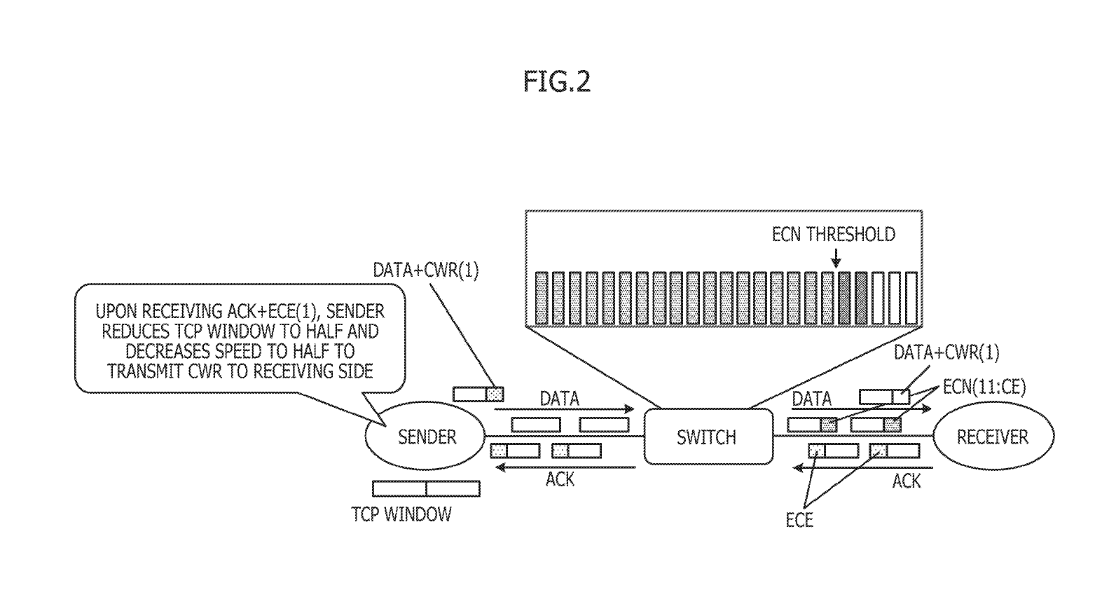

CWR and ECE are used in explicit congestion notification (ECN). FIG. 2 is a diagram for explaining ECN. As illustrated in FIG. 2, a sender sends DATA to a receiver via a switch. Upon detecting that a queue has exceeded an ECN threshold, the switch determines that congestion has occurred, and sets the ECN field of the packets to 11, which represents congestion experienced (CE), to send DATA to the receiver.

Then, the receiver sends ACK, in which ECN echo (ECE=1) is set, to the sender. The sender sets the TCP window to half and transmits DATA, in which CWR=1 is set, to the receiver. By storing entries relating to packets in which the TCP flag is CWR or ECE in the flow cache, the virtual switch according to the embodiment may detect CWR or ECE and carry out designated action.

Referring back to FIG. 1, the virtual switch according to the embodiment observes, in the measurement slot, the traffic volume of every flow cache entry. Furthermore, the virtual switch according to the embodiment monitors a communication channel between an OF processing unit that processes an OF table and an flow cache (FC) processing unit that processes the flow cache, and copies the communication information of exact match flows (Ex flows) to store the communication information in a candidate flow table. An exact match flow is a flow whose communication information completely matches with the communication information of a packet.

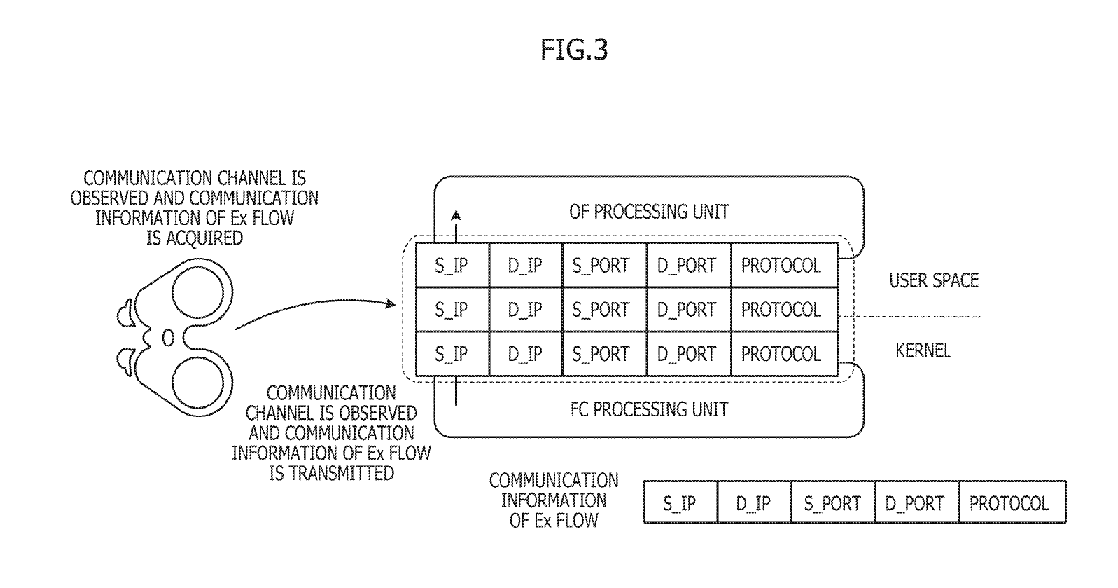

The Ex flow is an entry newly stored in the flow cache temporarily when an entry corresponding to the communication information of a packet does not exist in the flow cache. FIG. 3 is a diagram for explaining an Ex flow. In FIG. 3, S_IP is an IP address of a transmission source. D_IP is an IP address of a transmission destination. S_port is a port number of the transmission source. D_port is a port number of the transmission destination. Protocol is a protocol of communication.

All pieces of communication information of the Ex flow are stored in the flow cache as entries and a wildcard or information in units of subnet is not included in the entries of the Ex flow. Approximately 100 packets at the beginning are processed as the entries of the Ex flow and subsequent packets are newly added to the flow cache or are merged with existing entries. Finally, the entries of the Ex flow are deleted in order to process packets at high speed.

The candidate flow table is a table in which the Ex flows that become candidates for a long flow are stored as candidate flows. Among the Ex flows stored in the candidate flow table, the TCP flow that has ended in the measurement slot is given a penalty and is excluded from estimation as a long flow. Furthermore, the TCP flow with which congestion control has taken effect is given a penalty. The TCP flow that has ended is detected based on a packet in which the TCP flag is FIN (F) or RST (R), and the TCP flow with which congestion control has taken effect is detected based on a packet in which the TCP flag is CWR (C) or ECE (E).

In the estimation slot, the virtual switch according to the embodiment identifies a flow cache entry that satisfies a detection condition (1) and identifies candidate flows that belong to the identified flow cache entry (2). The detection condition is that the traffic volume (the total number of bytes) is 1 megabytes (MB) or larger, for example.

Then, the virtual switch according to the embodiment excludes a candidate flow with a penalty (for example, the value of the penalty is not 0%) from estimation as a long flow (3) and estimates only a candidate flow without a penalty (the value of the penalty is 0%) as a long flow (4). Then, the virtual switch according to the embodiment provides information of the candidate flow estimated as the long flow.

As described above, the virtual switch according to the embodiment employs Ex flows as candidate flows and estimates, among the candidate flows, a flow without a penalty and satisfying the detection condition as a long flow. Therefore, the virtual switch according to the embodiment may accurately estimate a long flow that matches the detection condition.

The virtual switch according to the embodiment may estimate a long flow based on a predetermined threshold (for example, 50%) of the penalty. Alternatively, the virtual switch according to the embodiment may estimate a long flow by using only the penalty without using the detection condition. Furthermore, the virtual switch according to the embodiment may detect only the TCP flow that has ended.

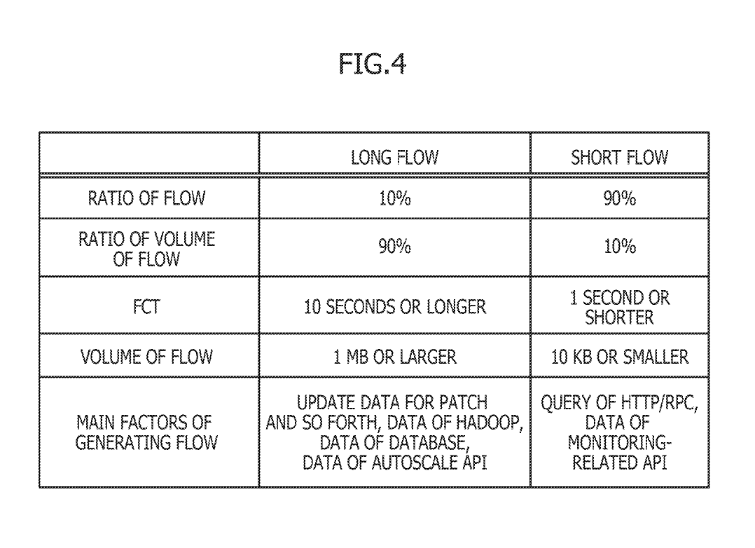

In the DCN, the flow has characteristics represented in FIG. 4. In the DCN, regarding the ratio of the flow, the long flow is 10% and the short flow is 90%. Regarding the ratio of the volume of the flow, the long flow is 90% and the short flow is 10%. Regarding the flow complete time (FCT), the long flow is 10 seconds or longer and the short flow is 1 second or shorter. Regarding the volume of the flow, the long flow is 1 MB or larger and the short flow is 10 kilobytes (KB) or smaller.

Regarding the main factors of generating the flow, the main factors of generating the long flow include, for example, update data for patch and so forth, data of Hadoop, data of a database, and data of an AutoScale application programming interface (API). The main factors of generating the short flow include, for example, a query of hypertext transfer protocol (HTTP)/remote procedure call (RPC), and data of a monitoring-related API.

As described above, in the DCN, 90% of the volume of the flows is the long flow. Therefore, the performance of the DCN may be controlled by carrying out path control of the long flow.

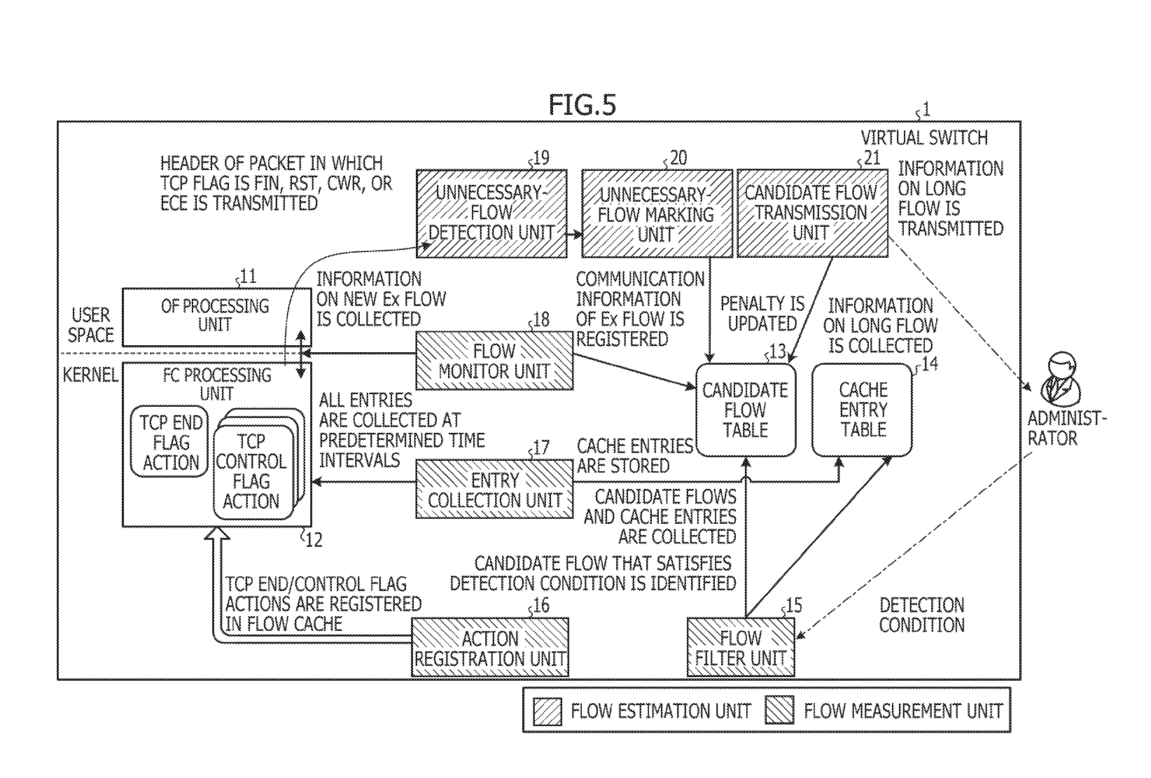

Next, a functional configuration of a virtual switch according to the embodiment will be described. FIG. 5 is a diagram illustrating a functional configuration of a virtual switch according to the embodiment. As illustrated in FIG. 5, a virtual switch 1 includes an OF processing unit 11, an FC processing unit 12, a candidate flow table 13, and a cache entry table 14. Furthermore, the virtual switch 1 includes a flow filter unit 15, an action registration unit 16, an entry collection unit 17, a flow monitor unit 18, an unnecessary-flow detection unit 19, an unnecessary-flow marking unit 20, and a candidate flow transmission unit 21.

The OF processing unit 11 executes processing on an OF table. The FC processing unit 12 executes processing on a flow cache. An entry of each table of the OF table and the flow cache includes the number of packets processed based on the entry, the number of bytes, and so forth. The OF processing unit 11 and the FC processing unit 12 transmit and receive the communication information of Ex flows and so forth.

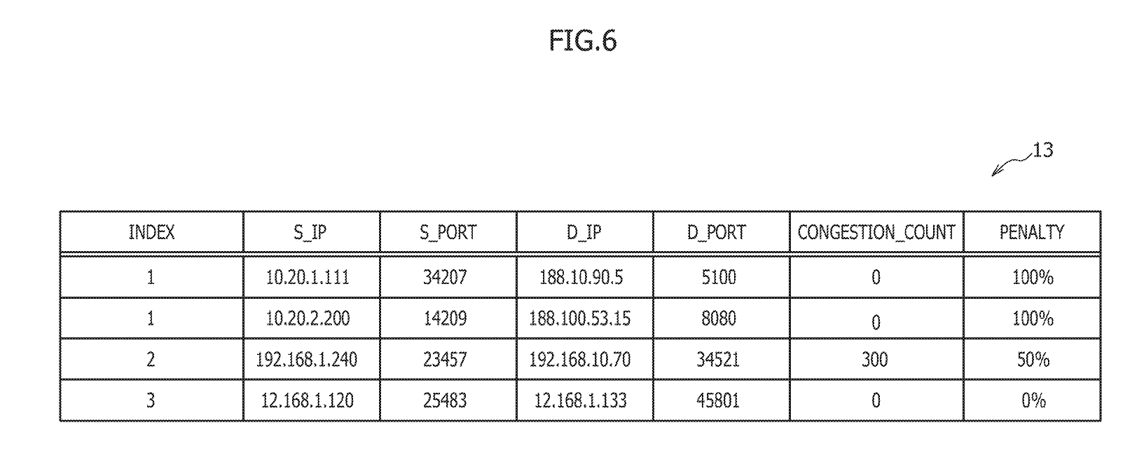

The candidate flow table 13 is a table in which information of Ex flows that become candidates for a long flow is stored as information of a candidate flow. FIG. 6 is a diagram illustrating an example of the candidate flow table 13. As illustrated in FIG. 6, in the candidate flow table 13, an index, S_IP, S_port, D_IP, D_port, congestion_count, and a penalty are stored for each candidate flow.

The index is a number to identify the entry in the flow cache regarding the candidate flow. The congestion_count is the number of times the congestion control flag (CWR or ECE) of the TCP has been detected in the candidate flow.

The penalty indicates the possibility that the candidate flow is not a long flow and is a value of 0% to 100%. When the value of the penalty is higher, the possibility that the candidate flow is not a long flow is higher. 100% is a state in which the end flag (FIN or RST) of the TCP has been detected, and indicates that the candidate flow is not a long flow. 0% is a penalty-free state in which none of the TCP flags has been detected, and indicates that the possibility that the candidate flow is a long flow is high. The initial value of the penalty is 0%.

1% to 99% is a state in which the congestion control flag of the TCP has been detected. The value of the penalty is calculated based on the occurrence frequency α=p/T of the congestion control flag of the TCP. Here, p is the number of packets in which the congestion control flag of the TCP has been detected, i.e. congestion_count, and T is the total number of packets of the cache entry. The cache entry is an entry of the flow cache. In a case of α=1, the value of the penalty is 99%.

For example, regarding the candidate flow whose entry number in the flow cache is “2”, the IP address of the transmission source is “192.168.1.240” and the port number of the transmission source is “23457”. Furthermore, the IP address of the transmission destination is “192.168.10.70” and the port number of the transmission destination is “34521”. The number of times the congestion control flag has been detected is “300” and the penalty is “50%”.

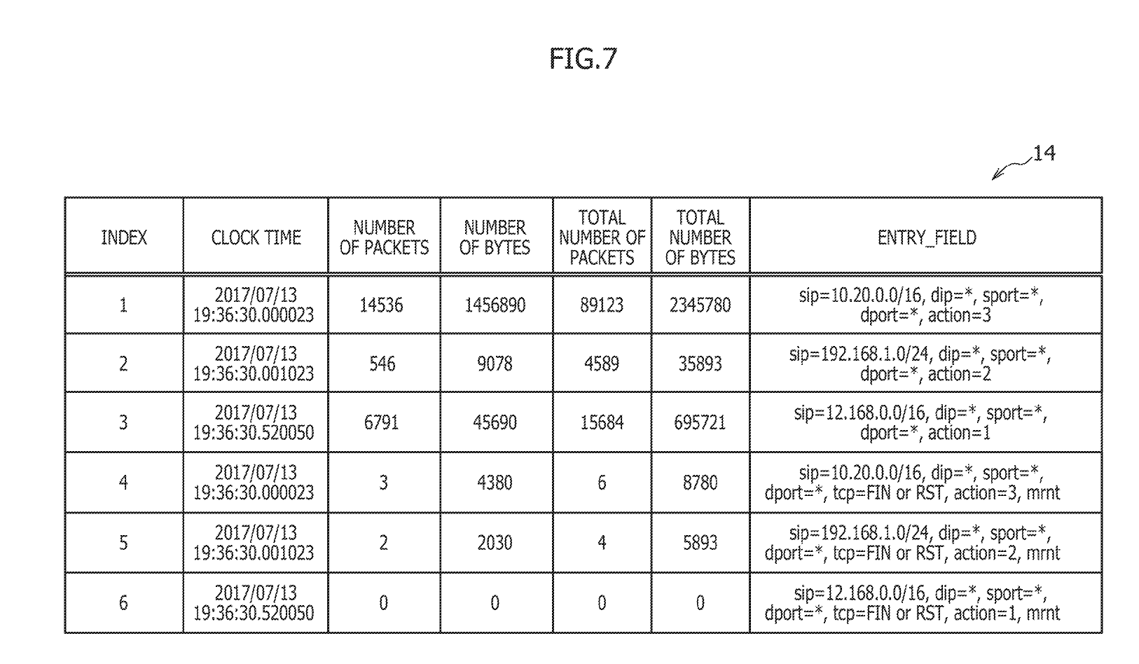

The cache entry table 14 is a table in which cache entries collected from the flow cache at predetermined time intervals are stored. FIG. 7 is a diagram illustrating an example of the cache entry table 14. As illustrated in FIG. 7, in the cache entry table 14, an index, a clock time, the number of packets, the number of bytes, the total number of packets, the total number of bytes, and an entry_field are stored for each cache entry.

The index is a number to identify a cache entry and corresponds to the index of the candidate flow table 13. The clock time indicates the time when the cache entry has been stored and includes the date and the time to microseconds. The number of packets is the number of packets transferred in a predetermined time by the flow corresponding to the cache entry. The number of bytes is the number of bytes of data transferred in the predetermined time by the flow corresponding to the cache entry. The total number of packets is the integrated value of the number of packets. The total number of bytes is the integrated value of the number of bytes. The entry_field indicates a match condition and an action of the cache entry. The match condition is a condition used for determining whether or not the cache entry matches the communication information of packets.

For example, the cache entry whose entry number in the flow cache is “1” has been stored in the flow cache at “2017/07/13 19:36:30.000023” and the number of packets transferred in the predetermined time is “14536”. The number of bytes of data transferred in the predetermined time is “1456890”. The integrated value of the number of packets is “89123” and the integrated value of the number of bytes is “2345780”. The match condition is “sip=10.20.0.0/16, dip=*, sport=*, dport=*”. The action is “action=3”.

Furthermore, the cache entry whose entry number in the flow cache is “4” has been stored in the flow cache at “2017/07/13 19:36:30.000023” and the number of packets transferred in the predetermined time is “3”. The number of bytes of data transferred in the predetermined time is “4380”. The integrated value of the number of packets is “6” and the integrated value of the number of bytes is “8780”.

The match condition is “sip=10.20.0.0/16, dip=*, sport=*, dport=*, tcp=FIN or RST”. Here, “tcp=FIN or RST” specifies that the TCP flag is FIN or RST. The action is “action=3, mrnt”. Here, “mrnt” specifies that the header of the packet is transferred to the unnecessary-flow detection unit 19.

In FIG. 7, the entries whose entry numbers in the flow cache are “4”, “5”, and “6” are entries stored in the flow cache in the initialization slot. In the measurement slot, the header of the packet is transferred to the unnecessary-flow detection unit 19 by the FC processing unit 12 and thereby the value of the penalty for the candidate flow corresponding to the header is updated.

The flow filter unit 15 accepts the detection condition of the long flow from the administrator of the network system in the initialization slot. Furthermore, the flow filter unit 15 extracts only the cache entries that satisfy the detection condition among the cache entries of the cache entry table 14 in the estimation slot and updates the penalty for the candidate flow that belongs to none of the extracted cache entries to 100%.

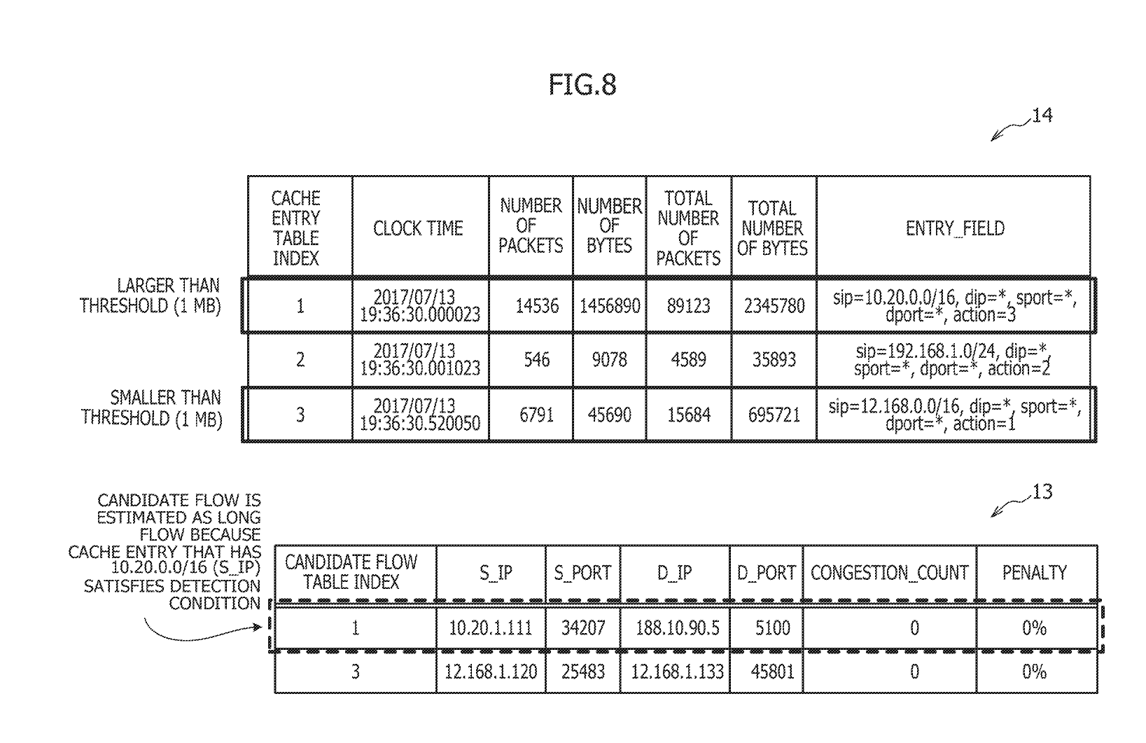

FIG. 8 is a diagram for explaining update of a penalty performed by the flow filter unit 15. In FIG. 8, the detection condition is that the total number of bytes is 1 MB or larger. The cache entry whose index of the cache entry table 14 is “1” has “2345780” as the total number of bytes and satisfies the detection condition. Furthermore, the candidate flow whose index of the candidate flow table 13 is “1” belongs to the cache entry whose index of the cache entry table 14 is “1” and has “0%” as the penalty and thus is estimated as a long flow.

On the other hand, the cache entry whose index of the cache entry table 14 is “3” has “695721” as the total number of bytes and does not satisfy the detection condition. Therefore, the candidate flow whose index of the candidate flow table 13 is “3” belongs to the cache entry whose index of the cache entry table 14 is “3” and does not satisfy the detection condition. For this reason, the penalty for the candidate flow whose index of the candidate flow table 13 is “3” is changed from “0%” to “100%” and is not estimated as a long flow.

Referring back to FIG. 5, the action registration unit 16 stores TCP end flag action and TCP control flag action in the flow cache. The TCP end flag action is a cache entry with which the FC processing unit 12 transmits the header of a packet in which the TCP flag is FIN or RST to the unnecessary-flow detection unit 19. The TCP control flag action is a cache entry with which the FC processing unit 12 transmits the header of a packet in which the TCP flag is CWR or ECE to the unnecessary-flow detection unit 19.

The entry collection unit 17 collects all cache entries from the flow cache at predetermined time intervals and stores the cache entries in the cache entry table 14.

The flow monitor unit 18 monitors a communication channel between the OF processing unit 11 and the FC processing unit 12. When a new Ex flow exists, the flow monitor unit 18 collects communication information of the new Ex flow and stores the communication information in the candidate flow table 13.

The unnecessary-flow detection unit 19 parses the header transmitted by the FC processing unit 12 and identifies communication information of the packet in which the TCP flag is FIN, RST, CWR, or ECE. The unnecessary-flow marking unit 20 calculates and updates the value of the penalty for the candidate flow corresponding to the communication information identified by the unnecessary-flow detection unit 19.

The candidate flow transmission unit 21 estimates a flow whose value of the penalty is 0% as a long flow from among the flows in the candidate flow table 13 and transmits information of the estimated flow to an administrator terminal used by the administrator. The administrator terminal displays the information of the long flow on a display device. The candidate flow transmission unit 21 may estimate a flow whose value of the penalty is equal to or smaller than a predetermined threshold as a long flow from among the flows in the candidate flow table 13.

In FIG. 5, the flow filter unit 15, the action registration unit 16, the entry collection unit 17, and the flow monitor unit 18 may be integrated as a flow measurement unit. The unnecessary-flow detection unit 19, the unnecessary-flow marking unit 20, and the candidate flow transmission unit 21 may be integrated as a flow estimation unit.

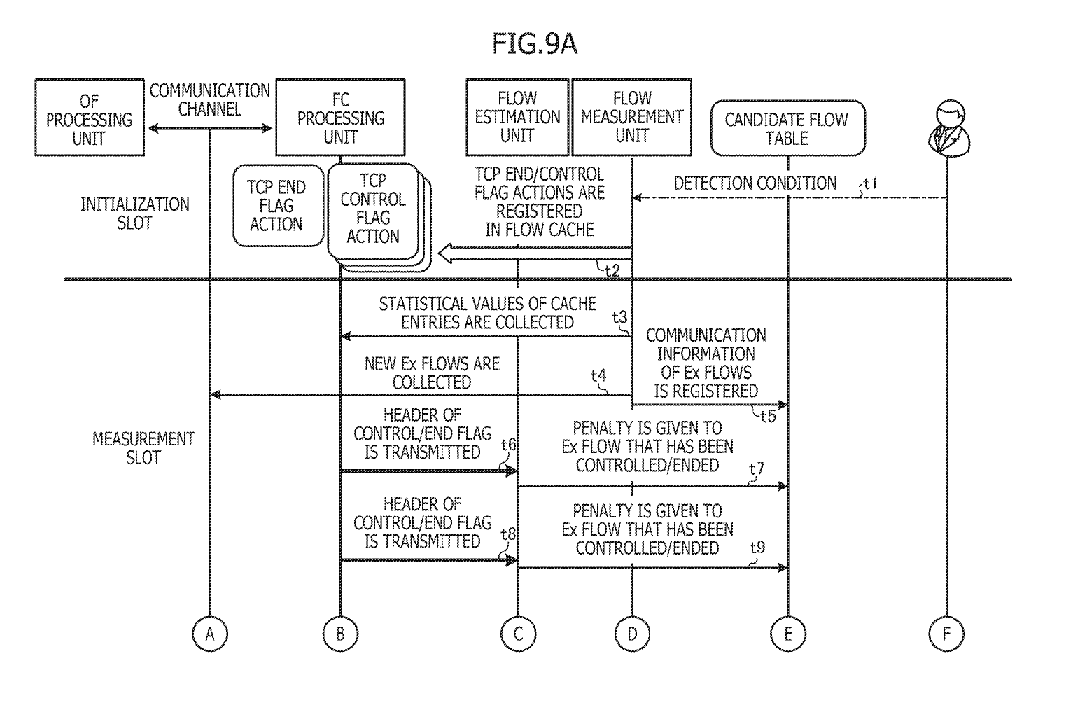

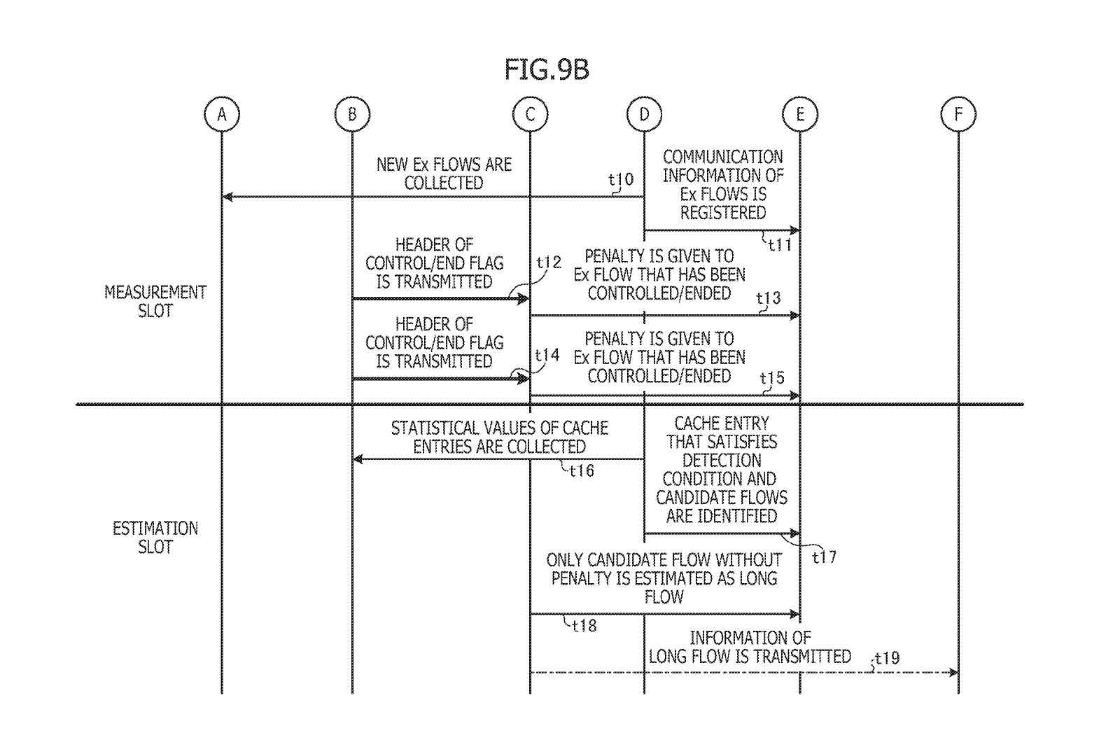

Next, time-series operations of the virtual switch 1 will be described. FIGS. 9A and 9B are diagrams illustrating time-series operations of the virtual switch 1. As illustrated in FIGS. 9A and 9B, in the initialization slot, the flow measurement unit accepts the detection condition from the administrator (t1). Then, the flow measurement unit stores TCP end flag action and TCP control flag action in the flow cache (t2).

In the measurement slot, the flow measurement unit collects statistical values of cache entries (t3). The statistical values are the number of packets, the number of bytes, the total number of packets, and the total number of bytes. Then, the flow measurement unit collects new Ex flows (t4) and stores the communication information of the Ex flows in the candidate flow table 13 (t5).

Then, the FC processing unit 12 transmits the header of the control/end flag to the flow estimation unit (t6). The header of the control/end flag is the header of a packet in which the TCP flag is FIN, RST, CWR, or ECE. Then, the flow estimation unit gives a penalty to the Ex flow, which has been controlled/ended, in the candidate flow table 13 (t7). The Ex flow that has been controlled/ended is a flow corresponding to a packet in which the TCP flag is FIN, RST, CWR, or ECE.

Then, the FC processing unit 12 transmits the header of the control/end flag to the flow estimation unit (t8). Then, the flow estimation unit gives a penalty to the Ex flow, which has been controlled/ended, in the candidate flow table 13 (t9).

Then, the flow measurement unit collects new Ex flows (t10) and stores the communication information of the Ex flows in the candidate flow table 13 (t11). Then, the FC processing unit 12 transmits the header of the control/end flag to the flow estimation unit (t12) and the flow estimation unit gives a penalty to the Ex flow, which has been controlled/ended, in the candidate flow table 13 (t13). Then, the FC processing unit 12 transmits the header of the control/end flag to the flow estimation unit (t14). Then, the flow estimation unit gives a penalty to the Ex flow that has been controlled/ended, in the candidate flow table 13 (t15).

The flow measurement unit repeats the collection of the statistical values of cache entries at predetermined time intervals. Furthermore, the flow measurement unit repeats the processing of collecting new Ex flows and storing the communication information of the Ex flows in the candidate flow table 13 in response to packets relayed by the virtual switch 1. The FC processing unit 12 repeats the transmission of the header of the control/end flag in response to packets relayed by the virtual switch 1. The length of the measurement slot is 10 seconds, for example.

In the estimation slot, the flow measurement unit collects the statistical values of cache entries (t16). Then, the flow measurement unit identifies a cache entry that satisfies the detection condition and identifies candidate flows that belong to the identified cache entry (t17). Then, the flow estimation unit estimates only the candidate flow without a penalty among the candidate flows identified by the flow measurement unit as a long flow (t18). Then, the flow estimation unit transmits information of the estimated long flow to the administrator terminal (t19).

As described above, the virtual switch 1 estimates, as a long flow, only the candidate flow without a penalty among the candidate flows that satisfy the detection condition and thus may accurately estimate the long flow. Instead of identifying, as a long flow, the candidate flow without a penalty among the candidate flows that satisfy the detection condition, the virtual switch 1 may identify, as a long flow, the candidate flow that satisfies the detection condition among the candidate flows without a penalty.

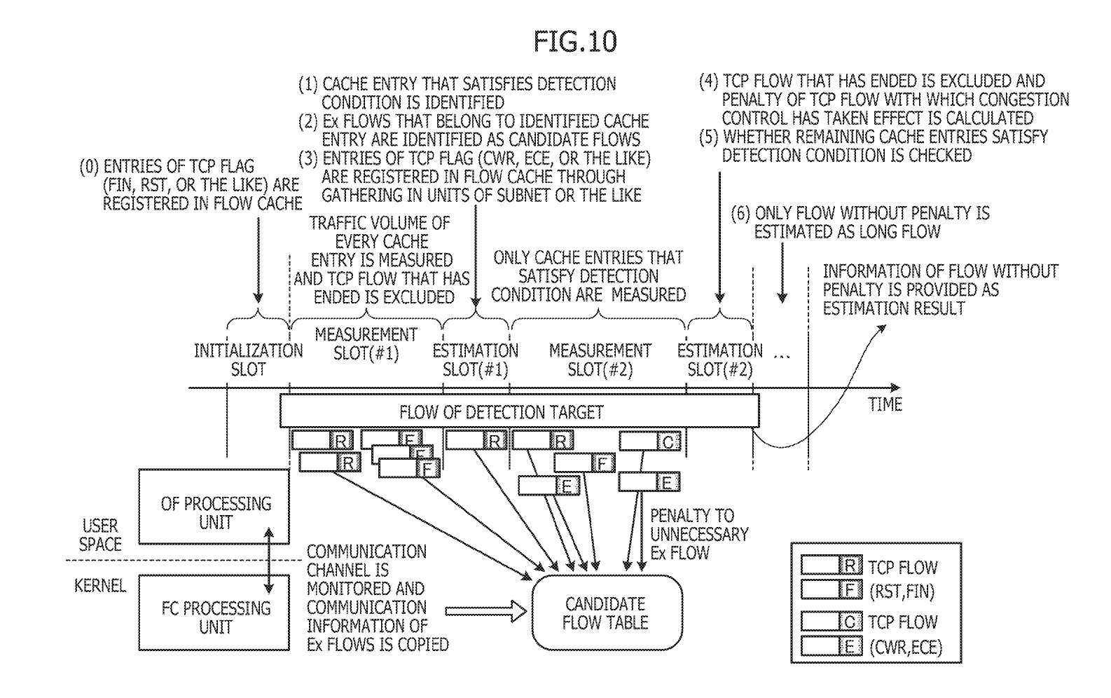

The virtual switch 1 may estimate a long flow in such a manner that the measurement slot and the estimation slot are divided into multiple slots. FIG. 10 is a diagram for explaining a flow estimation method in which a measurement slot and an estimation slot are divided into multiple slots. As illustrated in FIG. 10, in the initialization slot, the virtual switch 1 stores, in a flow cache, entries relating to packets in which the TCP flag is FIN, RST, or the like (0).

In a measurement slot (#1), the virtual switch 1 observes the traffic volume of every cache entry. Furthermore, the virtual switch 1 monitors the communication channel between the OF processing unit 11 and the FC processing unit 12 and copies the communication information of Ex flows to store the communication information in the candidate flow table 13. Moreover, the virtual switch 1 gives a penalty to the TCP flow that has ended and excludes the TCP flow from estimation as a long flow.

In an estimation slot (#1), the virtual switch 1 identifies a cache entry that satisfies the detection condition (1) and identifies Ex flows that belong to the identified cache entry as candidate flows (2). The virtual switch 1 stores, in the flow cache, entries relating to packets in which the TCP flag is CWR, ECE, or the like through gathering in units of subnet or the like (3).

In a measurement slot (#2), the virtual switch 1 observes only the cache entries that satisfy the detection condition. The virtual switch 1 monitors the communication channel between the OF processing unit 11 and the FC processing unit 12 and copies the communication information of Ex flows to store the communication information in the candidate flow table 13.

In an estimation slot (#2), the virtual switch 1 excludes the TCP flow that has ended and calculates the penalty for the TCP flow with which congestion control has taken effect (4). Then, the virtual switch 1 checks whether remaining cache entries satisfy the detection condition (5). Then, the virtual switch 1 estimates only the flow without a penalty as a long flow in the last estimation slot (#2) (6).

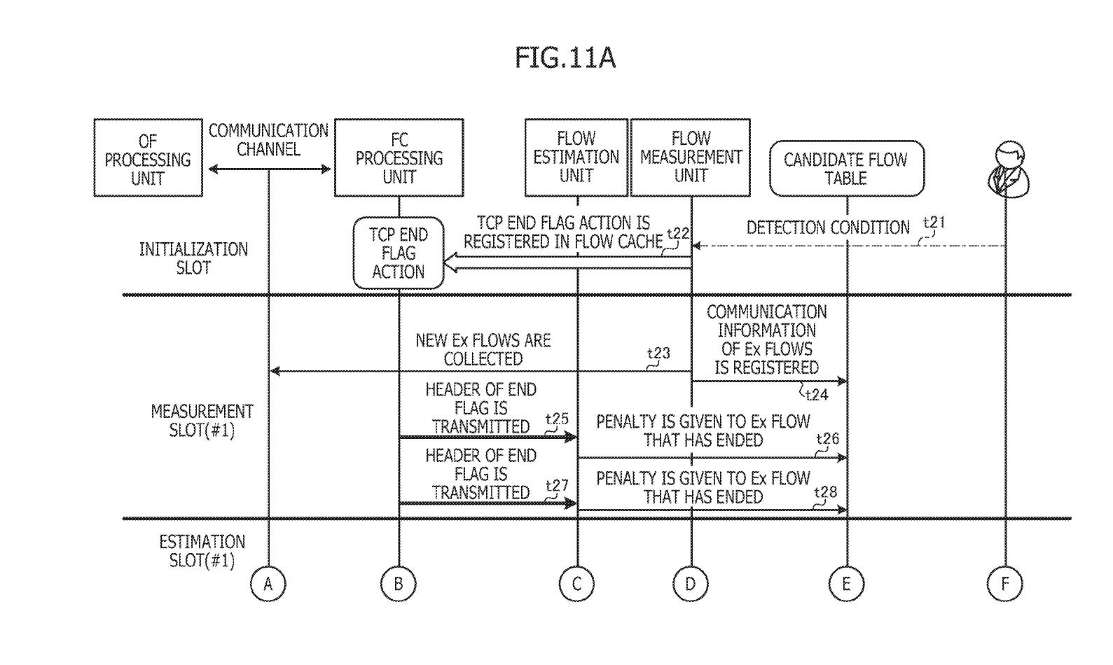

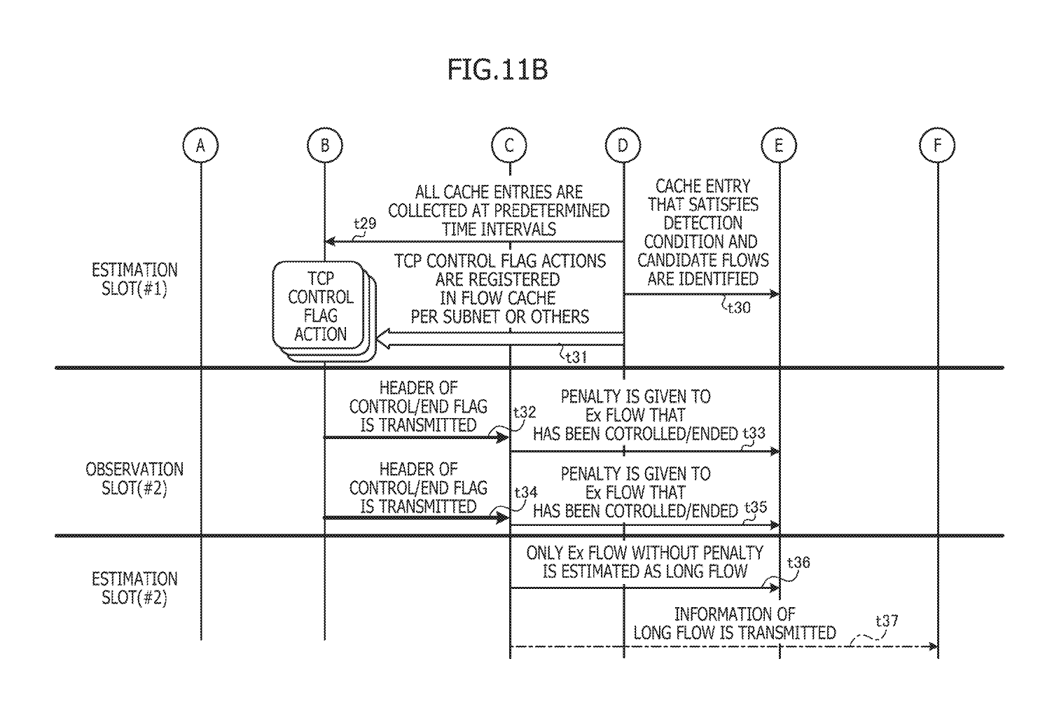

FIGS. 11A and 11B are diagrams illustrating time-series operations of the virtual switch 1 in the case of using the flow estimation method illustrated in FIG. 10. As illustrated in FIGS. 11A and 11B, in the initialization slot, the flow measurement unit accepts the detection condition from the administrator (t21). Then, the flow measurement unit stores TCP end flag action in the flow cache (t22).

In the measurement slot (#1), the flow measurement unit collects new Ex flows (t23) and stores the communication information of the new Ex flows in the candidate flow table 13 (t24). Then, the FC processing unit 12 transmits the header of the end flag to the flow estimation unit (t25). Then, the flow estimation unit gives a penalty to the Ex flow that has ended in the candidate flow table 13, in the candidate flow table 13 (t26). Then, the FC processing unit 12 transmits the header of the end flag to the flow estimation unit (t27). Then, the flow estimation unit gives a penalty to the Ex flow that has ended, in the candidate flow table 13 (t28).

In the estimation slot (#1), the flow measurement unit collects all cache entries at predetermined time intervals (t29). Then, the flow measurement unit identifies a cache entry that satisfies the detection condition and identifies Ex flows that belong to the identified cache entry (t30). The flow measurement unit stores TCP control flag actions in the flow cache through gathering in units of subnet or the like (t31).

In the measurement slot (#2), the FC processing unit 12 transmits the header of the control/end flag to the flow estimation unit (t32) and the flow estimation unit gives a penalty to the Ex flow that has been controlled/ended, in the candidate flow table 13 (t33). Then, the FC processing unit 12 transmits the header of the control/end flag to the flow estimation unit (t34). Then, the flow estimation unit gives a penalty to the Ex flow that has been controlled/ended, in the candidate flow table 13 (t35).

In the estimation slot (#2), the flow estimation unit estimates only the Ex flow without a penalty among the Ex flows identified by the flow measurement unit as a long flow (t36). Then, the flow estimation unit transmits information of the estimated long flow to the administrator terminal (t37).

As described above, the virtual switch 1 may raise the estimation accuracy by estimating the long flow in such a manner that the measurement slot and the estimation slot are divided into multiple slots.

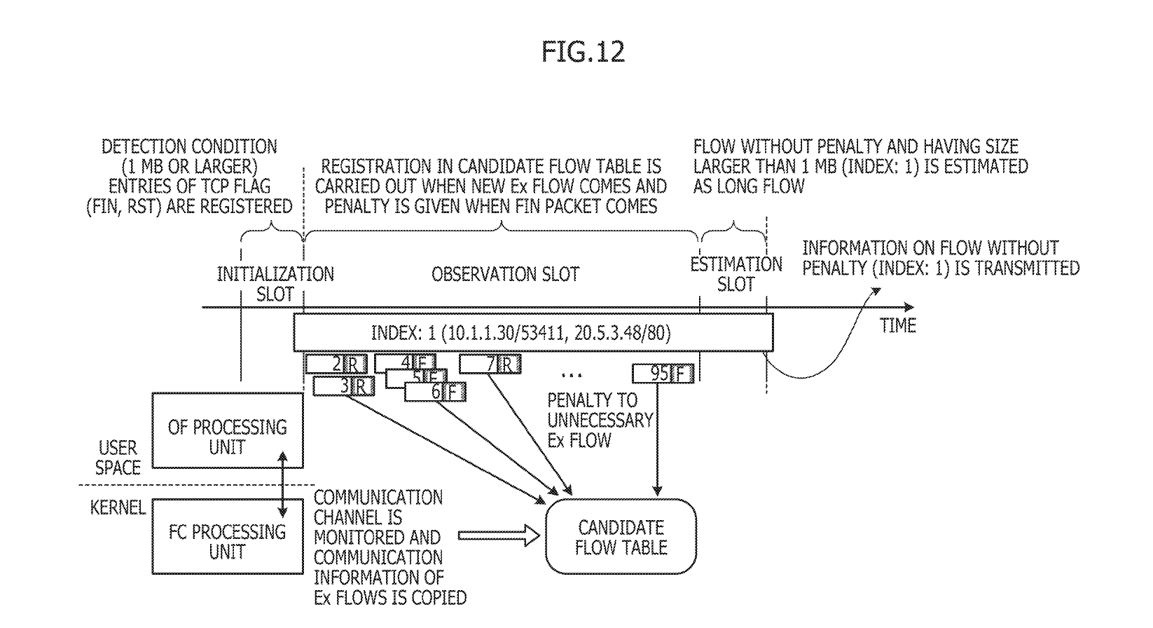

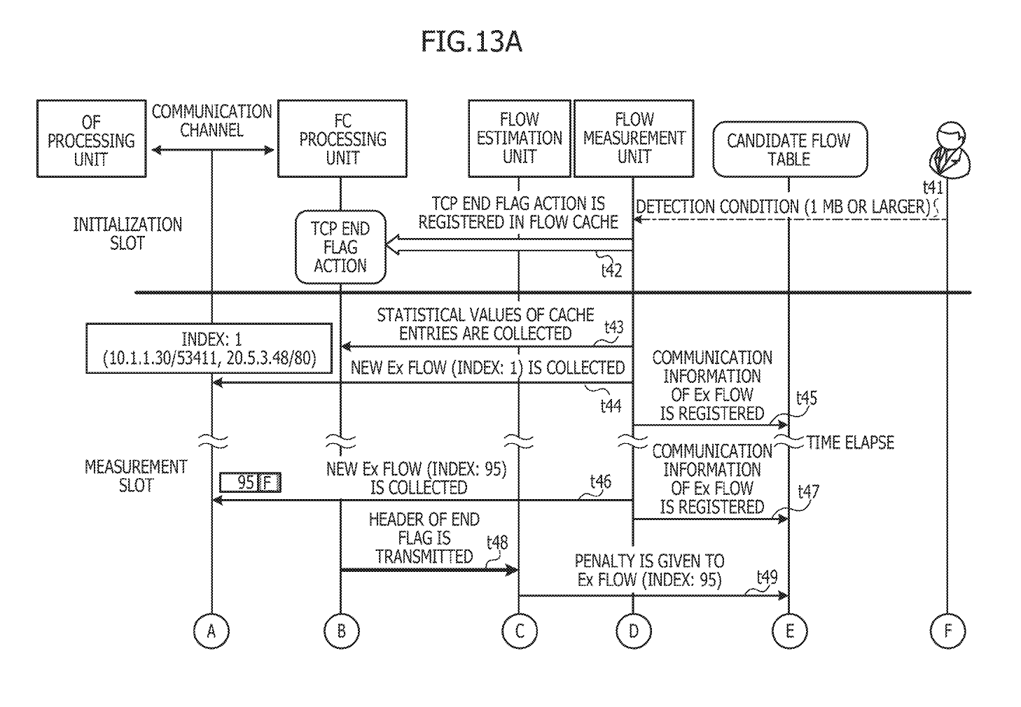

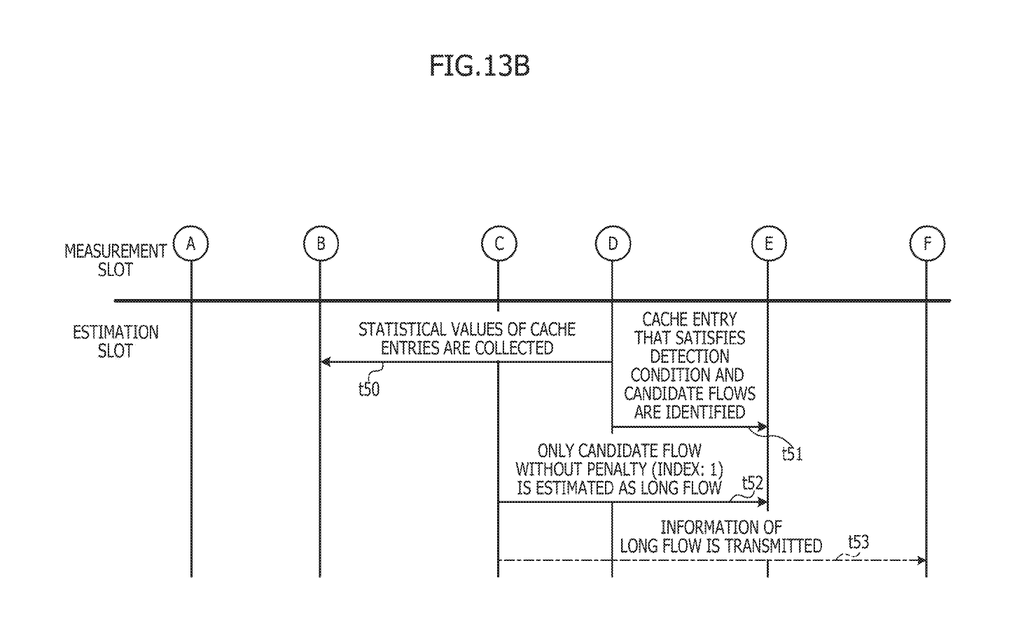

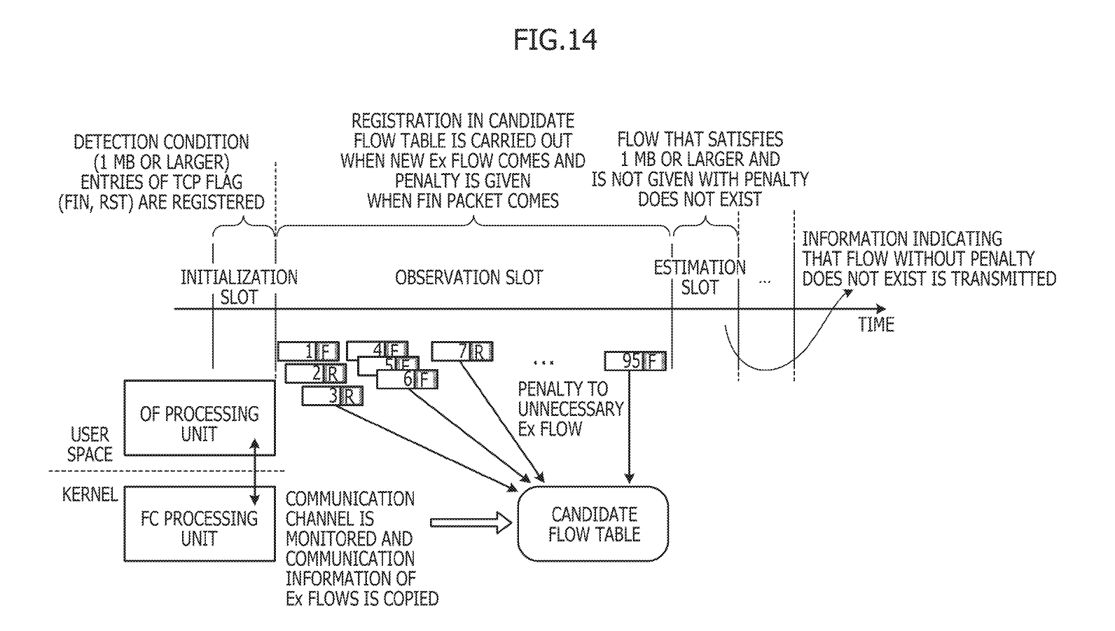

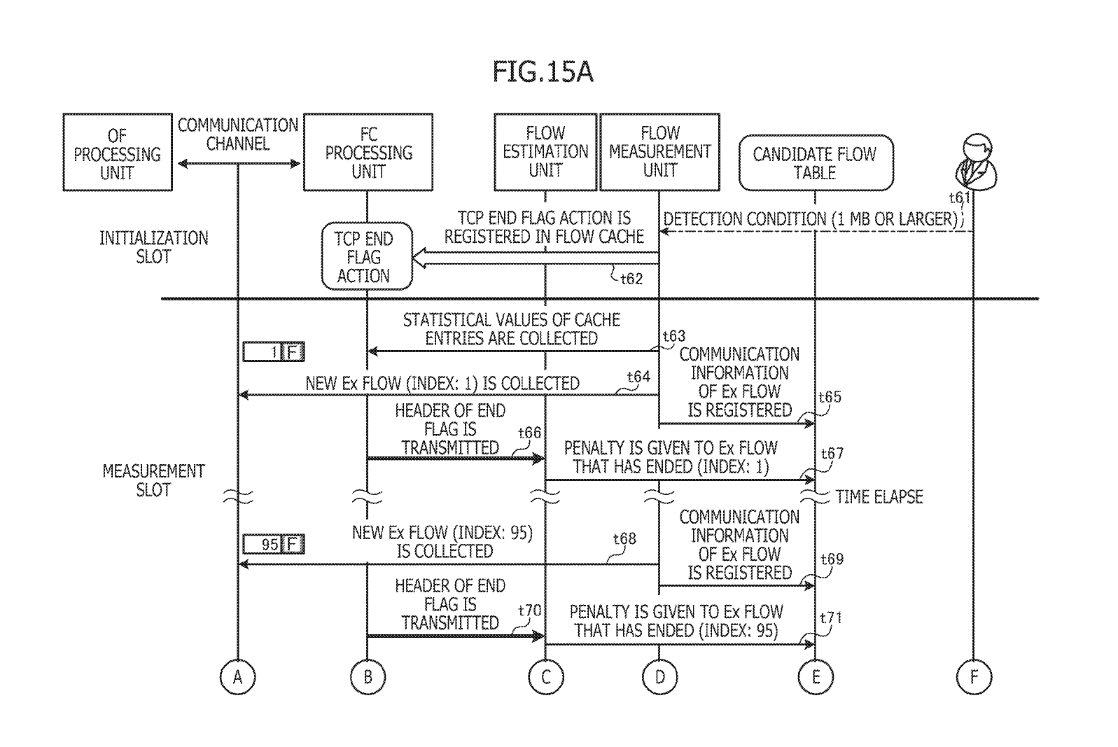

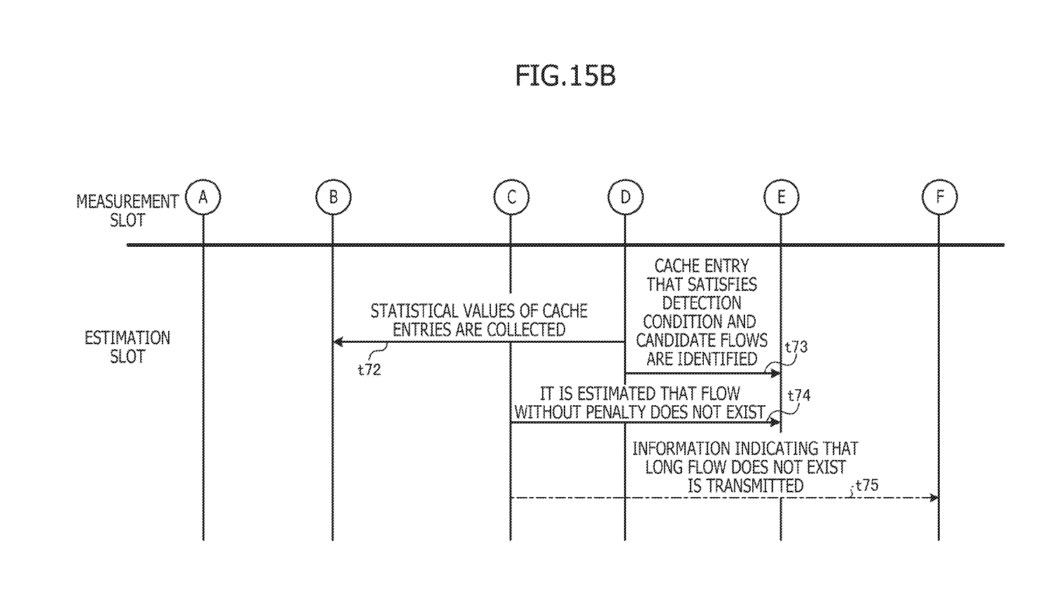

Next, examples of a process of estimating a long flow will be described with reference to FIG. 12 to FIGS. 15A and 15B. FIG. 12 and FIGS. 13A and 13B illustrate an example of a case in which a long flow exists and FIG. 14 and FIGS. 15A and 15B illustrate an example of a case in which a long flow does not exist. In the examples of FIG. 12 to FIGS. 15A and 15B, the virtual switch 1 uses only FIN and RST of the TCP flag and does not use CWR and ECE.

FIG. 12 is a diagram illustrating an example of a case in which a long flow exists. As illustrated in FIG. 12, in the initialization slot, the flow measurement unit accepts a condition that the total number of bytes is 1 MB or larger, as the detection condition, from the administrator and stores, in a flow cache, entries relating to packets in which the TCP flag is FIN or RST.

Then, in the measurement slot, the virtual switch 1 monitors the communication channel between the OF processing unit 11 and the FC processing unit 12 and copies the communication information of a new Ex flow to store the communication information in the candidate flow table 13. Here, an entry in which the index is “1” and the S_IP/S_port is “10.1.1.30/53411” and the D_IP/D_port is “20.5.3.48/80” is stored in the candidate flow table 13.

Thereafter, the virtual switch 1 copies the communication information of a new Ex flow and stores the communication information in the candidate flow table 13. Suppose that the index of the new Ex flow is “95” and the S_IP/S_port is “18.1.1.20/311” and the D_IP/D_port is “1.5.3.28/80”. Then, a FIN packet is detected with respect to the Ex flow whose index is “95” and the penalty for the Ex flow whose index is “95” is updated to “100%”.

Then, in the estimation slot, the virtual switch 1 estimates the flow without a penalty and satisfying the condition that the total number of bytes is 1 MB or larger as a long flow. Assuming that the total number of bytes of the Ex flow whose index is “1” is 1 MB or larger, the virtual switch 1 estimates the Ex flow whose index is “1” as a long flow and transmits information of the estimated long flow.

FIGS. 13A and 13B are diagrams illustrating time-series operations of the virtual switch 1 in a case in which a long flow exists. As illustrated in FIGS. 13A and 13B, in the initialization slot, the flow measurement unit accepts the detection condition (1 MB or larger) from the administrator (t41). Then, the flow measurement unit stores TCP end flag action in the flow cache (t42).

In the measurement slot, the flow measurement unit collects the statistical values of cache entries (t43). Then, the flow measurement unit collects a new Ex flow whose index is “1” (t44) and stores the communication information of the new Ex flow whose index is “1” in the candidate flow table 13 (t45).

Thereafter, the flow measurement unit collects a new Ex flow whose index is “95” (t46) and stores the communication information of the Ex flow whose index is “95” in the candidate flow table 13 (t47). Then, the FC processing unit 12 transmits the header of the end flag to the flow estimation unit (t48). Here, suppose that the index of the Ex flow regarding which the header is transmitted is “95”. Then, the flow estimation unit gives a penalty to the Ex flow whose index of the candidate flow table 13 is “95” (t49).

In the estimation slot, the flow measurement unit collects the statistical values of cache entries (t50). Then, the flow measurement unit identifies a cache entry that satisfies the detection condition and identifies candidate flows that belong to the identified cache entry (t51). Then, the flow estimation unit estimates only the candidate flow without a penalty among the candidate flows identified by the flow measurement unit as a long flow (t52). Here, the Ex flow whose index is “1” is estimated as a long flow. Then, the flow estimation unit transmits information of the estimated long flow to the administrator terminal (t53).

FIG. 14 is a diagram illustrating an example of a case in which a long flow does not exist. As illustrated in FIG. 14, in the initialization slot, the flow measurement unit accepts a condition that the total number of bytes is 1 MB or larger as the detection condition from the administrator and stores, in a flow cache, entries relating to packets in which the TCP flag is FIN or RST.

Then, in the measurement slot, the virtual switch 1 monitors the communication channel between the OF processing unit 11 and the FC processing unit 12 and copies the communication information of a new Ex flow to store the communication information in the candidate flow table 13. Here, an entry regarding which the index is “1” and the S_IP/S_port is “10.1.1.30/53411” and the D_IP/D_port is “20.5.3.48/80” is stored in the candidate flow table 13. Then, a FIN packet is detected regarding the Ex flow whose index is “1” and the penalty for the Ex flow whose index is “1” is updated to “100%”.

Thereafter, the virtual switch 1 copies the communication information of a new Ex flow and stores the communication information in the candidate flow table 13. Suppose that the index of the new Ex flow is “95” and the S_IP/S_port is “18.1.1.20/311” and the D_IP/D_port is “1.5.3.28/80”. Then, a FIN packet is detected regarding the Ex flow whose index is “95” and the penalty for the Ex flow whose index is “95” is updated to “100%”.

Then, in the estimation slot, the virtual switch 1 estimates the flow without a penalty and satisfying the condition that the total number of bytes is 1 MB or larger as a long flow. Here, the flow without a penalty and satisfying the condition that the total number of bytes is 1 MB or larger does not exist. Thus, the virtual switch 1 transmits information indicating that a long flow does not exist.

FIGS. 15A and 15B are diagrams illustrating time-series operations of the virtual switch 1 in a case in which a long flow does not exist. As illustrated in FIGS. 15A and 15B, in the initialization slot, the flow measurement unit accepts the detection condition (1 MB or larger) from the administrator (t61). Then, the flow measurement unit stores TCP end flag action in the flow cache (t62).

In the measurement slot, the flow measurement unit collects the statistical values of cache entries (t63). Then, the flow measurement unit collects a new Ex flow whose index is “1” (t64) and stores the communication information of the new Ex flow whose index is “1” in the candidate flow table 13 (t65). Then, the FC processing unit 12 transmits the header of the end flag to the flow estimation unit (t66). Here, suppose that the index of the Ex flow regarding which the header is transmitted is “1”. Then, the flow estimation unit gives a penalty to the Ex flow whose index of the candidate flow table 13 is “1” (t67).

Thereafter, the flow measurement unit collects a new Ex flow whose index is “95” (t68) and stores the communication information of the new Ex flow whose index is “95” in the candidate flow table 13 (t69). Then, the FC processing unit 12 transmits the header of the end flag to the flow estimation unit (t70). Here, suppose that the index of the Ex flow regarding which the header is transmitted is “95”. Then, the flow estimation unit gives a penalty to the Ex flow whose index of the candidate flow table 13 is “95” (t71).

In the estimation slot, the flow measurement unit collects the statistical values of cache entries (t72). Then, the flow measurement unit identifies a cache entry that satisfies the detection condition and identifies candidate flows that belong to the identified cache entry (t73). Then, the flow estimation unit estimates only the candidate flow without a penalty among the candidate flows identified by the flow measurement unit as a long flow, and estimates that a long flow does not exist (t74). Then, the flow estimation unit transmits information indicating that a long flow does not exist to the administrator terminal (t75).

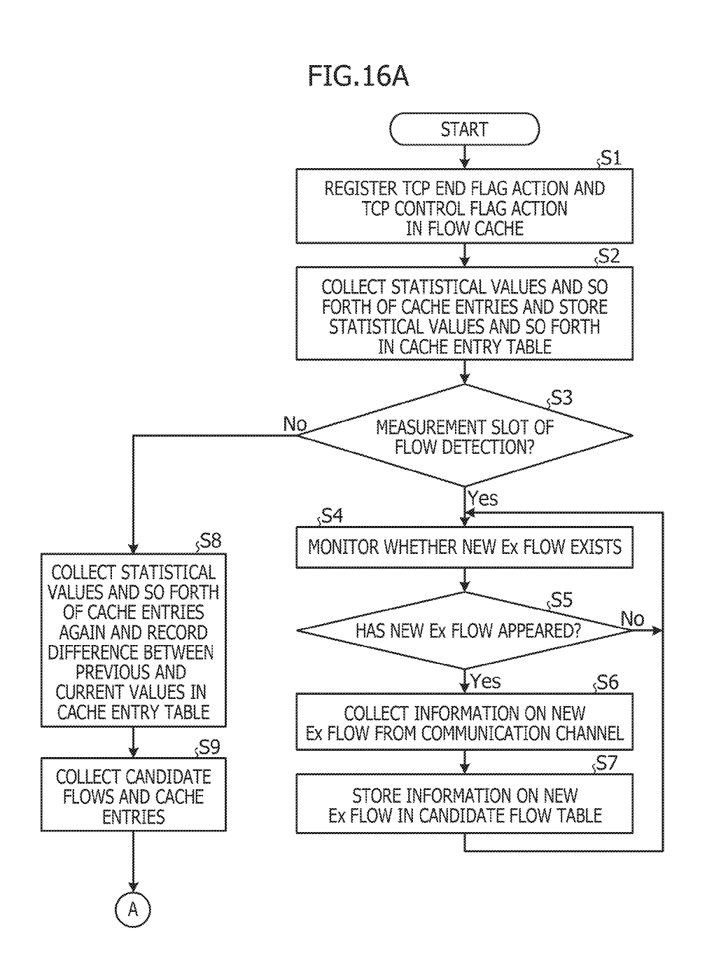

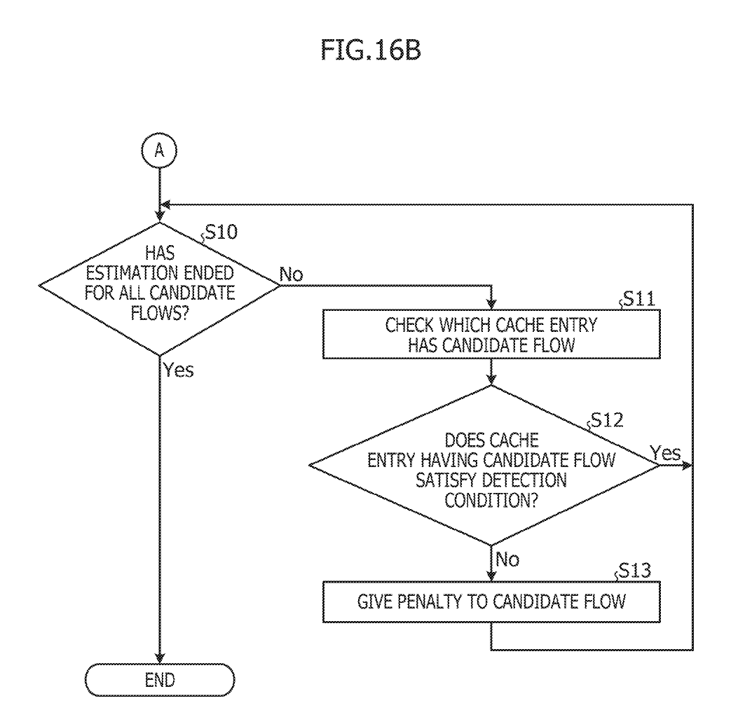

Next, a process performed by a flow measurement unit will be described. FIGS. 16A and 16B are flowcharts illustrating a process performed by the flow measurement unit. As illustrated in FIGS. 16A and 16B, the action registration unit 16 stores TCP end flag action and TCP control flag action in a flow cache (step S1).

Then, the entry collection unit 17 collects the statistical values and so forth of cache entries and stores the statistical values and so forth in the cache entry table 14 (step S2). Here, the statistical values and so forth of cache entries are collected only once in the measurement slot. However, the statistical values and so forth of cache entries may be collected multiple times in the measurement slot. Then, the flow measurement unit determines whether or not the present slot is the measurement slot of flow detection (step S3). When it is determined that the present slot is the measurement slot of flow detection, the flow monitor unit 18 monitors whether a new Ex flow exists (step S4).

Then, the flow monitor unit 18 determines whether or not a new Ex flow has appeared (step S5) and returns to the step S4 when it is determined that a new Ex flow has not appeared. When it is determined that a new Ex flow has appeared, the flow monitor unit 18 collects information of the new Ex flow from the communication channel (step S6) and stores the information of the new Ex flow in the candidate flow table 13 (step S7). Then, the flow monitor unit 18 returns to the step S4.

When it is determined that the present slot is not the measurement slot of flow detection in the step S3, the entry collection unit 17 collects the statistical values and so forth of cache entries again and stores the difference in the cache entry table 14 (step S8). Then, the flow filter unit 15 collects candidate flows and cache entries (step S9) and determines whether or not estimation has ended for all candidate flows (step S10). When it is determined that estimation has ended for all candidate flows, the flow measurement unit ends the processing.

When it is determined that a candidate flow for which estimation has not ended exists, the flow filter unit 15 checks which cache entry has the candidate flow (step S11) and determines whether or not the cache entry having the candidate flow satisfies the detection condition (step S12). When it is determined that the cache entry to which the candidate flow belongs satisfies the detection condition, the flow filter unit 15 returns to the step S10. When it is determined that the cache entry to which the candidate flow belongs does not satisfy the detection condition, the flow filter unit 15 gives a penalty to the candidate flow (step S13) and returns to the step S10.

As described above, the flow filter unit 15 gives a penalty to a candidate flow when it is determined that the cache entry to which the candidate flow belongs does not satisfy the detection condition. This allows the virtual switch 1 to estimate a long flow in such a manner that only the candidate flows that satisfy the detection condition are subjected to the estimation.

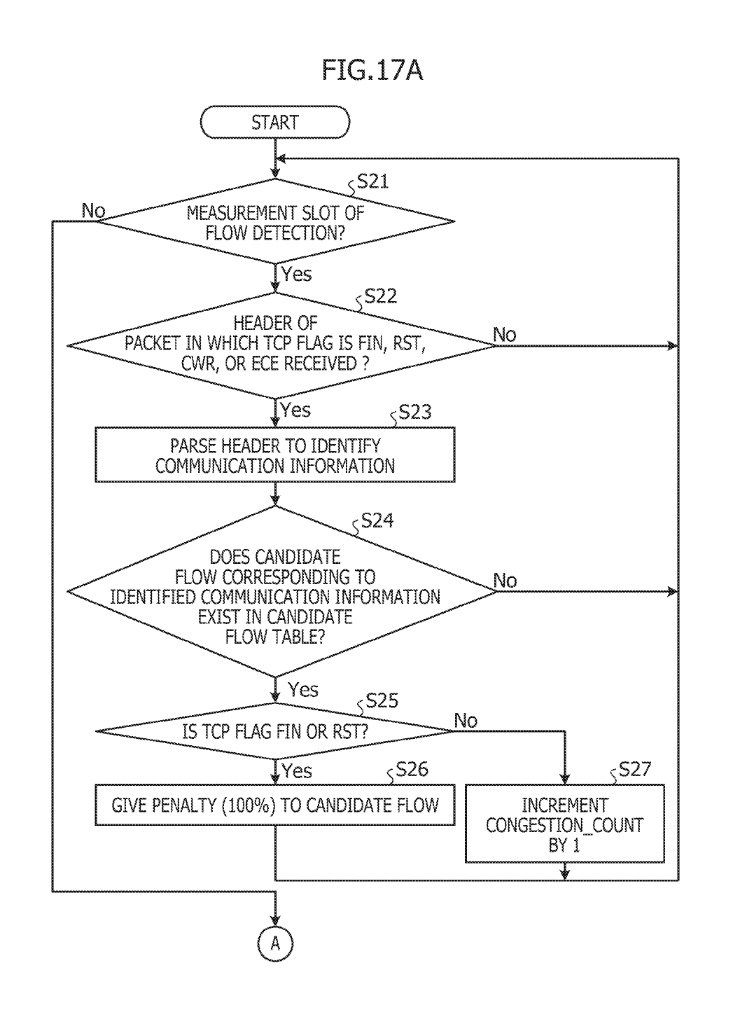

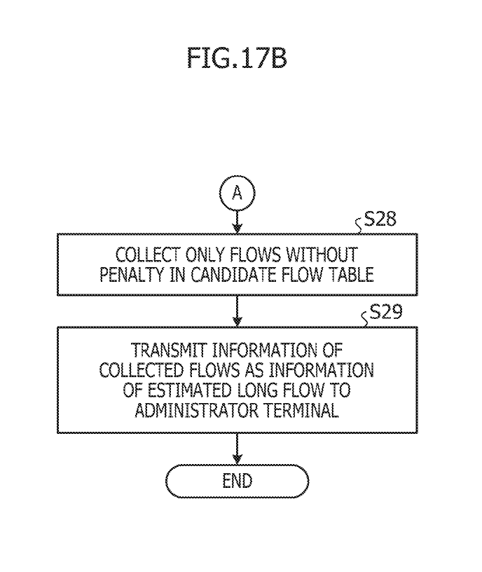

Next, a process performed by a flow estimation unit will be described. FIGS. 17A 17B are flowcharts illustrating a process performed by the flow estimation unit. As illustrated in FIGS. 17A 17B, the flow estimation unit determines whether or not the present slot is the measurement slot of flow detection (step S21). When it is determined that the present slot is the measurement slot of flow detection, the flow estimation unit determines whether or not the header of a packet in which the TCP flag is FIN, RST, CWR, or ECE has been received (step S22). When it is determined that the header of a packet in which the TCP flag is FIN, RST, CWR, or ECE has not been received, the flow estimation unit returns to the step S21.

When it is determined that the flow estimation unit has received the header of a packet in which the TCP flag is FIN, RST, CWR, or ECE, the unnecessary-flow detection unit 19 parses the header to identify communication information (step S23). Then, the unnecessary-flow detection unit 19 determines whether or not the candidate flow corresponding to the identified communication information exists in the candidate flow table 13 (step S24). When it is determined that the candidate flow does not exist, the flow estimation unit returns to the step S21.

When it is determined that the candidate flow corresponding to the identified communication information exists in the candidate flow table 13, the unnecessary-flow detection unit 19 determines whether or not the TCP flag is FIN or RST (step S25). When it is determined that the TCP flag is FIN or RST, the unnecessary-flow marking unit 20 gives a penalty (100%) to the candidate flow (step S26). When it is determined that the TCP flag is neither FIN nor RST, the unnecessary-flow marking unit 20 increments congestion_count by 1 (step S27). Then, the flow estimation unit returns to the step S21.

When it is determined that the present slot is not the measurement slot of flow detection in the step S21, the candidate flow transmission unit 21 collects only the flows without a penalty (0%) in the candidate flow table 13 (step S28). Then, the candidate flow transmission unit 21 transmits information of the collected flows as information of the estimated long flow to the administrator terminal (step S29).

As described above, the candidate flow transmission unit 21 collects only the flows without a penalty so that the virtual switch 1 may estimate the long flow.

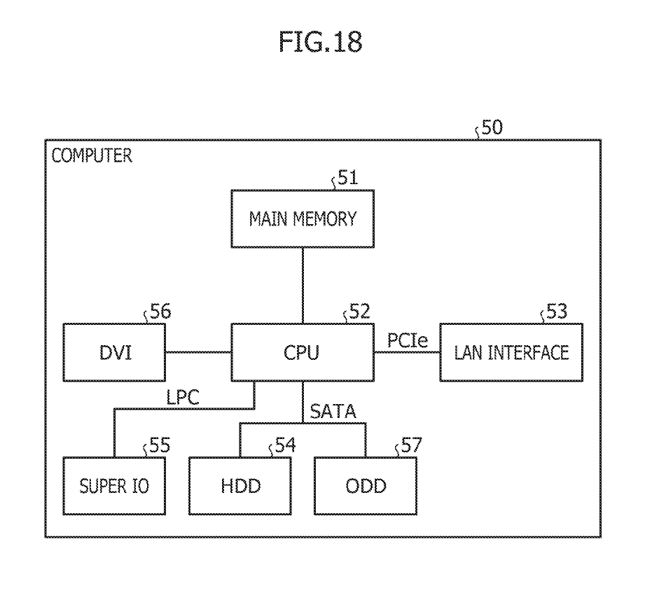

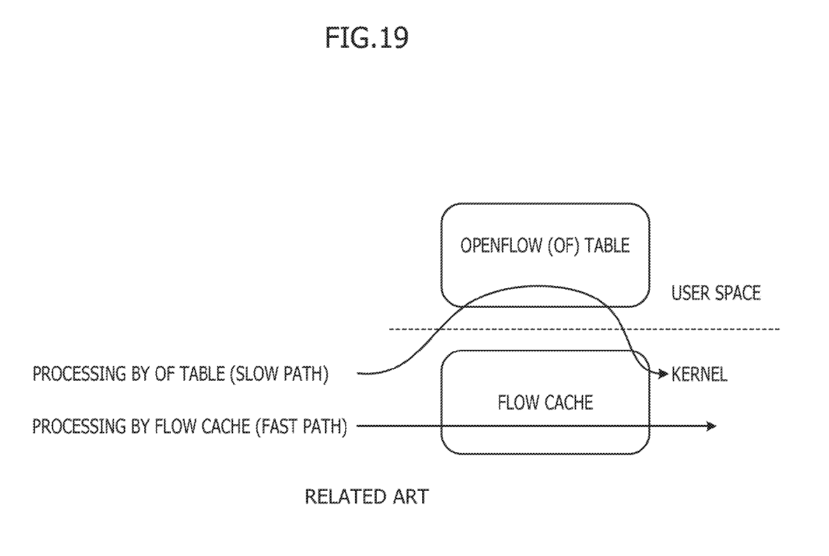

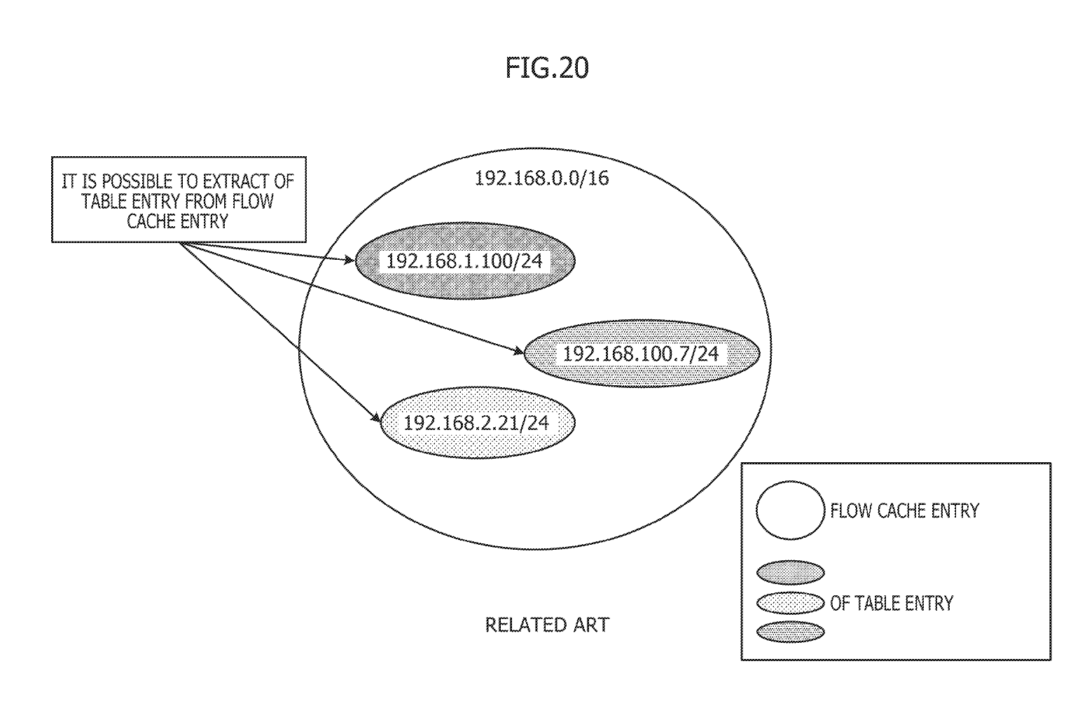

Next, a hardware configuration of a computer in which a virtual switch operates will be described. FIG. 18 is a diagram illustrating a hardware configuration of a computer in which the virtual switch 1 operates. As illustrated in FIG. 18, a computer 50 includes a main memory 51, a central processing unit (CPU) 52, a local area network (LAN) interface 53, and a hard disk drive (HDD) 54. Furthermore, the computer 50 includes a super input/output (IO) 55, a digital visual interface (DVI) 56, and an optical disk drive (ODD) 57.

The main memory 51 is a memory that stores a program, an intermediate result of execution of the program, and so forth. The CPU 52 is central processing device that reads out a program from the main memory 51 and executes the program. The CPU 52 includes a chipset including a memory controller.

The LAN interface 53 is an interface for coupling the computer 50 to another computer via a LAN. The HDD 54 is a disk device that stores programs and data. The super IO 55 is an interface for coupling pieces of input device such as mouse and keyboard. The DVI 56 is an interface to connect to a display device such as a liquid display device. The ODD 57 is a device that carries out reading and writing of a digital versatile disc (DVD).

The LAN interface 53 is coupled to the CPU 52 by the peripheral component interconnect express (PCIe). The HDD 54 and the ODD 57 are coupled to the CPU 52 by the serial advanced technology attachment (SATA). The super IO 55 is coupled to the CPU 52 by the low pin count (LPC).

A program that operates as the virtual switch 1 in the computer 50 is stored in a DVD, which is an example of a recording medium readable by the computer 50, and is read out from the DVD by the ODD 57 to be installed on the computer 50. Alternatively, the program that operates as the virtual switch 1 is stored in a database or the like of another computer system coupled via the LAN interface 53 and is read out from this database to be installed on the computer 50. Then, the installed program is stored in the HDD 54 and is read out into the main memory 51 to be executed by the CPU 52.

As described above, in the embodiment, the flow monitor unit 18 stores new Ex flows as candidate flows in the candidate flow table 13. Then, the unnecessary-flow marking unit 20 updates the penalty for the candidate flow identified based on the header of a packet in which the TCP flag is FIN, RST, CWR, or ECE. Then, the candidate flow transmission unit 21 estimates a long flow based on the penalty and transmits information of the estimated long flow to an administrator terminal. Therefore, the virtual switch 1 may efficiently estimate the long flow and provide information of the long flow.

In the embodiment, the flow filter unit 15 gives a penalty to the flow that does not satisfy the detection condition among candidate flows. This allows the virtual switch 1 to exclude the flow that does not satisfy the detection condition from estimation as a long flow.

Moreover, in the embodiment, the flow monitor unit 18 monitors the communication channel between the OF processing unit 11 and the FC processing unit 12 and detects new Ex flows. Thus, candidate flows may be surely stored in the candidate flow table 13.

In the embodiment, the action registration unit 16 stores TCP end flag action and TCP control flag action in the flow cache. Then, the FC processing unit 12 transmits the header of a packet in which the TCP flag is FIN, RST, CWR, or ECE to the unnecessary-flow detection unit 19. Then, the unnecessary-flow detection unit 19 identifies a candidate flow from among the flows in the candidate flow table 13 based on the communication information included in the header and updates the penalty for the identified candidate flow. Therefore, the virtual switch 1 may exclude the flow that has ended and the flow for which congestion control has been carried out from estimation as a long flow.

In the embodiment, the virtual switch 1 estimates only the flow whose total number of bytes is 1 MB or larger as a long flow and thus may estimate only long flows having a significant influence on the network.

In the embodiment, the virtual switch 1 observes only entries of the flow cache to estimate the long flow instead of observing entries of both the OF table and the flow cache to estimate the long flow. Thus, the virtual switch 1 may efficiently estimate the long flow.

For example, suppose that the number of entries of the flow cache is 4, the number of tables included in the OF table is 20, and the number of entries of each table is 300. In a case of observing entries of both the OF table and the flow cache, 4×20×300=2400 entries are observed. However, in the embodiment, the virtual switch 1 only needs to observe four entries.

In the embodiment, the case in which the candidate flow table 13, the cache entry table 14, the flow estimation unit, and the flow measurement unit are included in the virtual switch 1 is described. However, the candidate flow table 13, the cache entry table 14, the flow estimation unit, and the flow measurement unit may be implemented by an apparatus different from the virtual switch 1.

In the embodiment, the case in which flows are relayed by the virtual switch 1 is described. However, flows may be relayed by a physical switch. Although the case of estimating the long flow is described in the embodiment, a flow having another characteristic, such as a short flow, may be estimated.

In the embodiment, the virtual switch 1 identifies the end and congestion control of the TCP flows by using the packet in which the TCP flag is FIN, RST, CWR, or ECE. However, the virtual switch 1 may identify the end and congestion control of flows by another method.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus comprising:
a memory; and
a processor coupled to the memory and the processor configured to:
relay flows each including a stream of packets;
collect information of a candidate flow based on information of the relayed flows, the candidate flow being a candidate for a flow to be estimated as a target flow having a predetermined characteristic;
calculate a penalty value for the candidate flow based on information included in a packet of the candidate flow, the penalty value indicating a possibility that the candidate flow does not have the predetermined characteristic;
estimate the candidate flow as the target flow based on the calculated penalty value; and
output information of the candidate flow estimated as the target flow.

2. The information processing apparatus according to claim 1, wherein
the processor is further configured to:
estimate the candidate flow as the target flow when the candidate flow satisfies a predetermined detection condition.

3. The information processing apparatus according to claim 1, wherein
the processor is further configured to:
capture first flow information to be stored in a flow cache, the first flow information including a source internet protocol (IP) address of a first flow, a destination IP address of the first flow, a source port number of the first flow, and a destination port number of the first flow, the flow cache storing flow information of a flow in association with information of a corresponding action; and
employ the first flow as the candidate flow.

4. The information processing apparatus according to claim 3, wherein
the processor is further configured to:
calculate the penalty value based on information transmitted in accordance with a first action stored in the flow cache in association with the first flow information.

5. The information processing apparatus according to claim 1, wherein
the predetermined characteristic is that the stream of packets of the target flow is transmitted for a predetermined period.

6. The information processing apparatus according to claim 1, wherein
the processor is further configured to:
calculate the penalty value based on a transmission control protocol flag included in the packet of the candidate flow, the transmission control protocol flag being FIN, RST, CWR, or ECE.

7. The information processing apparatus according to claim 2, wherein
the predetermined detection condition is that an amount of data included in the candidate flow is equal to or larger than a predetermined threshold.

8. An information processing method comprising:
relaying, by a computer, flows each including a stream of packets;
collecting information of a candidate flow based on information of the relayed flows, the candidate flow being a candidate for a flow to be estimated as a target flow having a predetermined characteristic;
calculating a penalty value for the candidate flow based on information included in a packet of the candidate flow, the penalty value indicating a possibility that the candidate flow does not have the predetermined characteristic;
estimating the candidate flow as the target flow based on the calculated penalty value; and
outputting information of the candidate flow estimated as the target flow.

9. A non-transitory computer-readable recording medium having stored therein a program that causes a computer to execute a process, the process comprising:
relaying flows each including a stream of packets;
collecting information of a candidate flow based on information of the relayed flows, the candidate flow being a candidate for a flow to be estimated as a target flow having a predetermined characteristic;
calculating a penalty value for the candidate flow based on information included in a packet of the candidate flow, the penalty value indicating a possibility that the candidate flow does not have the predetermined characteristic;
estimating the candidate flow as the target flow based on the calculated penalty value; and
outputting information of the candidate flow estimated as the target flow.
